(19) United States
(12) Patent Application Publication
(10) Pub. No.: US 2024/0019340 A1
(43) Pub. Date: Jan. 18, 2024

(54) SYSTEMS, DEVICES AND METHODS FOR A REPEATABLE AND QUANTIFIABLE MEASUREMENT OF THE HAZE PRESENT IN AN OPTICAL LENS

(71) Applicant: Younger Mfg. Co. dba Younger Optics, Torrance, CA (US)

(72) Inventors: Michael Pearson, Cerritos, CA (US); Andrew Mckenzie, San Pedro, CA (US); Joseph Berta, Sherwood, OR (US)

(21) Appl. No.: 18/352,841

(22) Filed: Jul. 14, 2023

Related U.S. Application Data
(60) Provisional application No. 63/482,561, filed on Jan. 31, 2023.
(60) Provisional application No. 63/389,302, filed on Jul. 14, 2022.

(51) Int. Cl. G01M 11/02

(52) U.S. Cl. CPC G01M 11/0285

(57) ABSTRACT

Systems, devices and methods to measure a haze value of a lens using a light proof box housing a stand, a light source and a camera. The stand has an orientation to position the lens to be flat, adjacent to the light source, and have the lens edge facing the light source. The light source is configured to emit a blue light into a lens edge of the lens. The camera is oriented to face a top surface of the lens, the camera is configured to measure blue light emitted from the top surface of the lens. A computing device coupled with the camera is configured to calculate the haze value of the lens based on the measured blue light.

### RELATED APPLICATION INFORMATION

This patent claims priority from U.S. Provisional Patent Application No. 63/482,561, titled HAZE METER II, filed Jan. 31, 2023 and U.S. Provisional Patent Application No. 63/389,302, titled HAZE METER, filed Jul. 14, 2022, the contents of which are included by reference herein in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

Systems, devices and methods for a repeatable and quantifiable measurement of the haze present in an optical lens, such as by only emitting blue light into the lens and/or only measuring blue light in the lens.

### Description of the Related Art

Haze may influence the overall clarity or visual acuity of lens. Thus, it may be desired to measure an amount of haze or a haze value of a lens. The amount of haze may depend on the amount of impurities in the lens or layers of the lens. The amount of haze may vary depending on amounts of additives mixed into the resin used to form the lens, such as photochromic dyes, UV absorbers, hindered amine light stabilizers (HALS), antioxidants, and mold release agents. Additionally, the amount of haze can be dependent on the intrinsic clearness of the lens with or without these additives. Greater amounts of additives and/or less intrinsically clear the lenses generally lead to greater amounts haze. What is needed is the ability to quickly, inexpensively and accurately measure an amount of haze in or a haze value of a lens, such as a lens blank or an optical lens prior to mounting the lens in a frame or offering it for sale.

### DESCRIPTION OF THE DRAWINGS

FIG. 1 is a block diagram of a system for repeatable and quantifiable measurement of the haze present in an optical lens.

FIG. 2 is an image histogram for a high haze lens.

FIG. 3 is an image histogram for a low haze lens.

FIG. 4 shows a flow chart of an operating environment or process flow for repeatable and quantifiable measurement of the haze present in an optical lens.

FIG. 5 is a block diagram of a computing device.

Throughout this description, elements appearing in figures are assigned three-digit or four-digit reference designators, where the two least significant digits are specific to the element and the one or two most significant digit is the figure number where the element is first introduced. An element that is not described in conjunction with a figure may be presumed to have the same characteristics and function as a previously-described element having the same reference designator or the same two least significant digits.

### DETAILED DESCRIPTION

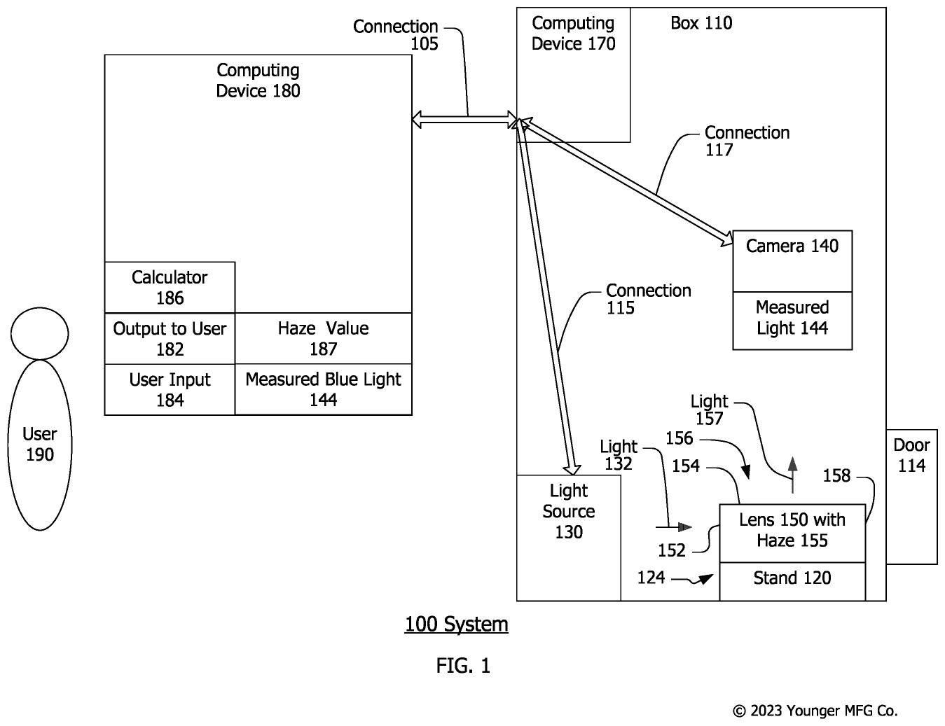

Technologies described herein provide systems, devices and methods for a repeatable and quantifiable measurement of the haze present in an optical lens, such as by only emitting blue light into the lens and/or only measuring blue light emitted from the top surface of the lens. These technologies, referred to herein separately and collectively as a ‘haze meter,’ have been developed to address the inadequacy of existing commercially available haze measurement instruments and standard techniques in certain specific cases, such as for measuring haze 155 of a lens 150 as shown in FIG. 1. The technologies provide the ability to quickly, inexpensively and accurately measure an amount of haze in or a haze value of a lens, such as a lens blank prior to manufacture of an optical lens or an optical lens prior to mounting the lens in a frame or offering it for sale.

The lens may be a blank that has not yet been processed, a final product lens for mounting in a frame, a sample of a lens material, or a lens at any stage of processing therebetween. The haze may influence the overall clarity or visual acuity of lens. The amount of haze measured may be an amount of haze or a haze value as known in the art. The haze meter may measure the amount of haze or haze value as known in the art. The amount of haze 155 may depend on the amount of impurities in the lens or layers, as well as the presence of damage to the front surface, such as scratches, or contamination, such as fingerprints. The amount of haze may vary depending on amounts of additives mixed into the lens resin, such as photochromic dyes, UV absorbers, hindered amine light stabilizers (HALS), antioxidants, and mold release agents. Additionally, the amount of haze can be dependent on the intrinsic clearness of the lens with or without these additives. Greater amounts of additives and/or less intrinsically clear lenses generally lead to greater amounts haze. The amount of haze may also appear to vary depending on the edge quality of the lens. A lens edge with high surface roughness may add between 10-12% haze to the average apparent value.

### DESCRIPTION OF APPARATUS

Referring now to FIG. 1, there is shown a block diagram of a system 100 for a repeatable and quantifiable measurement of the haze 187 present in an optical lens 150. Descriptions herein of being “configured to”, “configured for” or “for” an action may mean that units, components or systems are configured to and/or adapted to perform that action, such as a part of repeatable and quantifiable measurement of the haze present in the optical lens.

The system 100 includes box 110 having door 114, stand 120, light source 130 and camera 140. A lens 150 may be mounted on the stand 120 to receive light 132 emitted by the source 130 and for having light 157 that is emitted from the top surface 154 of the lens 150 measured by camera 140 as measured light 144. The lens 150 is optional. It may represent any one of a number of lenses having its haze value 187 measured by the system 100 and/or box 110. For example, system 100 and/or box 110 is a haze meter for measuring a haze value 187 of a lens which is to be oriented on stand 120 such as by only emitting blue light into the lens and/or only measuring blue light in the lens.

Box 110 is a light proof box housing the stand 120, the light source 130 and the camera 140 inside the box. Box 110 may be a housing with outer surfaces of or including various light blocking materials. Box 110 has door 114 for accessing the lens 150, stand 120 and optionally other components inside the box. When door 114 is closed, light does not enter box 110 from an external source or ambient. Door 114 may provide a user access to the box 110 to mount and/or orient the lens 150 on the stand 120 at orientation 156 within the box 110.

Stand 120 may be placed in orientation 124 to position 156 the lens 150 to be flat, horizontally adjacent to the light source 130, and have the lens edge 152 facing the emitted light 132 of light source 120. Stand 120 may include or be a mount having a flat top surface and clamps or a retaining device for removably retaining the lens 150 in a fixed position 156 with respect to the light source 120 and the camera 140. Stand 120 is shown as a separate component, and it may be part of a bottom surface of the box 110.

Light source 130 is for emitting a blue light 132 into the lens edge 152. In some cases, blue light 132 includes other colors of light in the human visual range. In other cases, source 130 only emits the blue light 132 and does not emit another color light. The light source 130 may be a light emitting diode (LED), a laser, or another source of light having blue light.

Source 130 may be for emitting the blue light 132 from the lens edge 152 to an opposing edge 158 of the lens 150, such as using a collimated beam having a circular cross-sectional diameter of between 0.5 and 3 mm. This diameter may be equal to or less than a thickness of the lens 150. This diameter may be less than the thickness. In other cases, it may be greater than the thickness.

Lens 150 has top surface 154 facing camera 140, edge 152 facing source 130 and edge 158 opposite of edge 152. The edges may be parallel. Edge 158 may be or include a part or perimeter of the lens 150 that is farthest from edge 152 The lens has a circular cross section from above and a thickness. A bottom surface of the lens 150 may be positioned on stand 120. A haze 155 of or in lens 150 can be measured as part of light 157 from which haze value 187 can be calculated.

Light 157 is emitted from the lens 150 or from top surface 154. Light 157 may be the part of light 132 that is emitted from surface 154. Light 157 may have the same color as light 132, except that light 157 may include or be changed by the haze 155 that gives haze value 187. The color of the emitted light 157 may also be altered by its interaction with the lens material and/or any dyes, pigments, or other additives inside lens 150. These factors can influence the spectral characteristics and color composition of the emitted light 157, which in turn contributes to haze 155 and the measured haze value 187.

Lens 150 can have various configurations depending on its intended use and design. The front surface of the lens can be considered a single vision surface, where it provides a consistent curvature across its entire surface. Alternatively, the front surface can be a complex surface that exhibits continuously changing surface curvature. Furthermore, the front surface can accommodate a bifocal or multifocal lens design. Lens 150 includes one or more of: an optical material; a hard coat; a photochromic dye, a film; a polarizer dye, layers of optical material known for glasses or optical lenses; a lens blank base layer of polyurethane with a second layer of photochromic material, such as formed from a liquid into a solid; various base curvatures; and/or various optical grindings and/or optical prescriptions.

Camera 140 is oriented to face top surface 154 of the lens 150. Camera 140 is configured for measuring blue light 157 emitted from the top surface 154 as measured light 144. Measured light 144 may be image data of the emitted light 157. Camera 140 may have an imager facing and for imaging top surface 154. Camera 140 may have an orientation that includes having a viewing direction (e.g., an optical axis, principal axis, or principal ray of the camera) oriented perpendicular to the top surface 154. Measuring the blue light 157 that is emitted from the top surface 154 may include measuring the blue light inside or between the top surface 154 and a bottom surface of the lens.

Camera 140 may measure the emitted light 157 of an image of the lens 150 and haze 155 such as by producing measured light 144 of the emitted light 157. Measured light 144 includes image data of the haze 155.

In some cases, blue light 157 includes other colors of light, such as when light 132 does as well. In other cases, camera 140 only measures the blue light 157 and does not measure another color light. In some cases, light source 120 only emits the blue light 132 and the camera 140 only measures the blue light 157. In some cases, light source 120 only emits the blue light 132 or the camera 140 only measures the blue light 157. Blue light 132 and/or blue light 157 may only have wavelengths between (and including) 430 and 485 nanometers (nm).

System 100 also includes computing device 180 having a data connection to box 110 through data connection 105. Device 180 receives light 144 used to calculate value 187. Device 180 is for calculating the haze value 187 of the lens based on the measured blue light 144, such as described further below.

Calculating the haze value 187 may be performed by calculator 186 of device 180. Calculator 186 may be or include computer hardware, logic and/or software instructions that cause the calculation to occur.

Value 187 of an amount of haze 155 of lens 150 may be, be proportional to and/or include the amount of light that is subject to wide angle scattering at an angle greater than 2.5° from normal (ASTM D1003) as opposed to an amount of clarity which may be the amount of light that is subject to narrow area scattering at an angle less than 2.5° from normal.

If light 152 and 157 are not only blue light, device 180 and/or calculator 186 may calculate value 187 using only the blue light wavelengths of light 157 and/or 144, such as by filtering or only processing the blue light wavelengths of light 157 to form light 144. In this case, light 152 and 157 may be or include white light or light including blue and other wavelengths of light emitted by the light source and measured by the camera. Hardware, digital, software processing and/or camera imaging can be used to only image the blue light as light 144.

Device 180 and/or calculator 186 may include non-transitory computer instructions that when executed by the computing device 180 cause the device 180 and/or calculator 186 to receive user input via user input device 184 to control the light source 130 to emit only the blue light 132 and/or control the camera to measure only the blue light 157. The instructions may also cause calculating the haze value 187 of the lens 150 based on the measured blue light 144.

Device 180 provides output to the user via user output device 182 such as a computer display and receives user input via user input device 184 such as a mouse, touchscreen and/or keyboard. The user output device 182 and user input device 184 enable the user 190 to control the system 100, box 110 source 130 and/or camera 140. Input device 184 may receive user selections, light source instructions and camera instructions received to be sent to source 130 and the camera 140. In some cases, input device 184 receives user inputs (instructions, commands) of user selections to perform repeatable and quantifiable measurements of the haze 155 as haze value 187.

Connection 105 is a data connection external to box 110 and device 180 from the computing device 180 to the light source 130 and the camera 140. Data connection 150 may be used by the computing device 180 to send user selections, light source instructions and camera instructions received at input device 184 to source 130 and the camera 140. Data connection 105 may be used by the box 110 and the camera 140 therein to send measured light 144 information (data) from camera 140 to device 180. Connection 105 may be a wired, wireless, internet or other data connection.

Box 110 also includes data connections 115 and 117 between connection 105 and source 310 and camera, respectively. Data connections 115 and 117 may be used by the computing device 180 and/or 170 to send user selections, light source instructions and camera instructions received at input device 184 to source 130 and the camera 140, respectively. In some cases, connections 115 and 117 are from device 170 instead of from connection 105.

Data connections 105, 115 and 117 may be wired, wireless, Bluetooth, WIFI, USB, Ethernet or other data connections between electronic devices and/or computing devices. They may be point to point, broadcast or multipoint connections.

There may be external power connections such as from a wall outlet or other power supply to device 180, device 170, source 130 and camera 140. In some cases, these power connections may be part of connections 105, 115 and 117.

User 190 may control the door 114, stand 120, orientation 124, position 156, orientation of source 130 and/or orientation of camera 140 through input 184. User 190 may control the time and length of emission of light 132 from source 130 and/or the measuring of light 157 by camera 140. User 190 may control the calculator 186 and/or calculating of haze value 187, such as based on the histogram and/or equation. User 190 may be a person and/or human being. In other cases, user 190 may represent a computing device, AI or neural network.

Any one or more of the actions of the system, devices, components and/or controlled by user 190 may be performed automatically. Automatically may describe when an action occurs without user input to cause, guide or select that action's course, end or selection. Any one or more of the actions may be performed repeatedly such as to obtain another haze value 187 for the same lens 150; or to obtain a haze value 187 for a different lens 150. Any one or more of the actions may be or be part of a quantifiable measurement by device 180 or calculator 186 of the haze value 187 present in the optical lens 150.

Box 110 may optionally include computing device 170 having some or all of the components of device 180 and/or for performing some or all of the actions of device 180. In this case, the components and actions of device 180 may be split among devices 170 and 180 in any amount. Device 170 may have a user input device and user output device similar to user input device 184 and user output device 182 of computing device 180. The user 190 may receive outputs from and make inputs to device 170 and/or 180. Device 170 may be a part of box 110 connected to and between connection 105 and the stand 120, light source 130 and/or camera 140.

System 100, device 180 and/or calculator 186 calculating the haze value 187 may include using the measured blue light 144 to calculate an average pixel value of the light 144 from pixels of surface 154 for a histogram having of N bins that depict the brightness of individual pixels captured in the measured blue light 144 (e.g., of light 157) where bin 0 represents a bin of completely dark light of light 144, and bin N represents a bin of completely light/bright light of light 144. This average pixel value of the light 144 may be the haze value 187.

For example, bin 0 may represent a bin of completely dark light, defined as very low intensity or undetectable light as light 157, where no haze 155 is scattering or reflecting the blue light 132, so light 157 and light 144 are dark (e.g., no blue light 132 is in light 157 and 144). In this case, bin N may present a bin of completely bright light where a lot of haze is blocking and/or reflecting the blue light 132 into being light 157, so light 157 and light 144 are completely light (e.g., a lot of blue light 132 is in light 157 and 144).

Calculating the average pixel value (e.g., haze value 187) may be calculating the summation of the x-value of a bin (e.g., brightness value of a bin number from 0 to N, such as 1 for bin 1 and 17 for bin 17) multiplied by the bar height at that bin location (such as 7 percent at bin 1 and 1 percent at bin 17) which is a number of pixels present at that bin location (e.g., having that brightness from 0 to N), and dividing the summation by the total number of pixels (e.g., P) in the image to get the average pixel value.

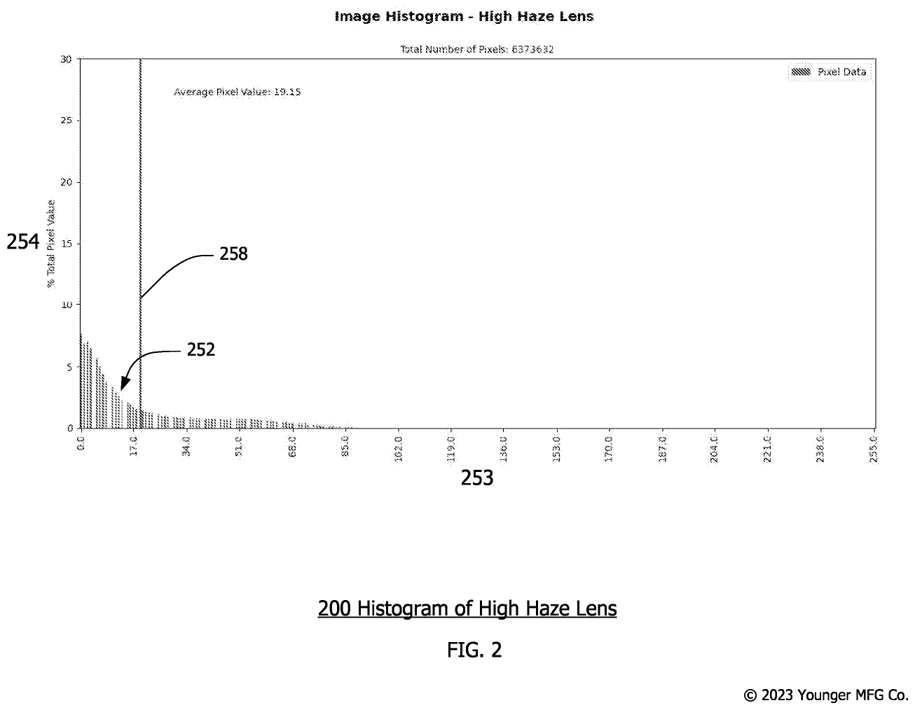

For example, FIG. 2 is an image histogram 200 for a high haze lens version of lens 150. Histogram 200 shows pixel data blue vertical lines of brightness bin values 252 of bins 253 plotted for percent (%) of total pixel value 254. Histogram 200 shows an example where N is 256. Histogram 200 shows an exponentially dropping curve of values 252 for 256 bins from bin 0 representing completely dark data of light 144 to bin 256 representing completely light data of light 144.

In this example where N is 256 bins (such as for 6E6 pixels of the surface 154 of lens) bin 0 represents completely dark, and bin 255 represents completely light, calculating the average pixel value may use the equation:

$$Avg Pixel Value = \frac{1}{TotalPixelCount} * {\sum }_{bin = 0}^{255} ( bin * {PixelCount}_{b i n} ) .$$

In the example of FIG. 2, the average pixel value (e.g., haze value 187) is shown at line 258 as 19.15. Histogram 200 may be calculated by device 180, device 170 and/or calculator 186 to calculate haze value 187 as the average 258.

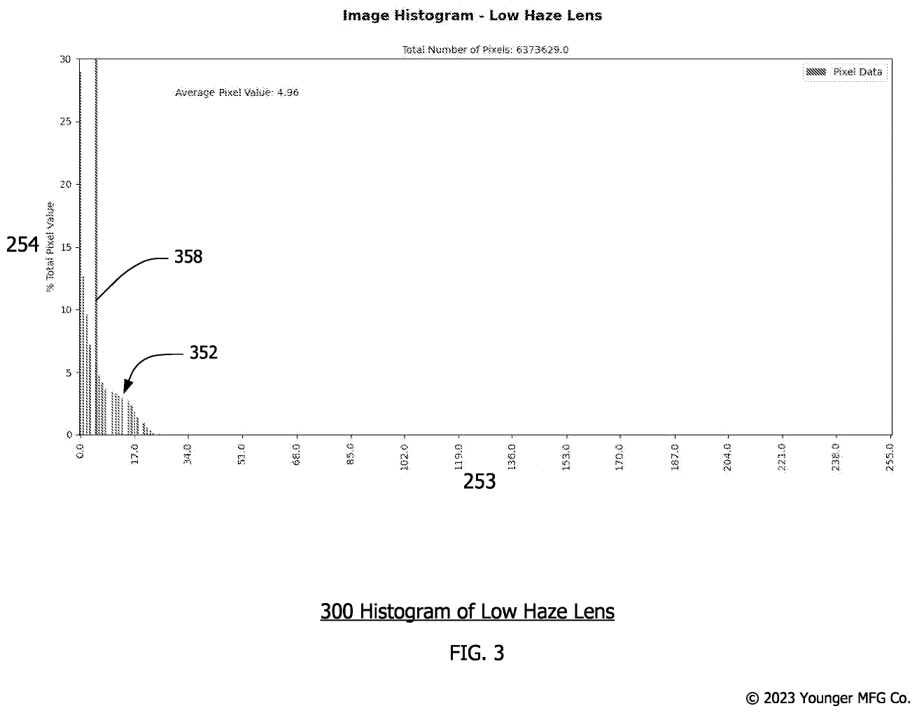

In another example, FIG. 3 is an image histogram 300 for a low haze lens version of lens 150. Histogram 300 shows pixel data blue vertical lines of brightness bin values 352 of bins 253 plotted for percent (%) of total pixel value 254. Histogram 300 shows an example where N is 256. Histogram 300 shows a more linear and more quickly dropping curve of values 352 for 256 bins from bin 0 representing completely dark data of light 144 to bin 256 representing completely light data of light 144. In the example of FIG. 3 the average pixel value (e.g., haze value 187) is shown at line 358 as 4.96. Histogram 200 may be calculated by device 180, device 170 and/or calculator 186 to calculate haze value 187 as the average 358.

An acceptable haze value threshold for lens 150 is determined based on the desired level of visual clarity. The average pixel value (e.g., haze value 187) is used as a measure of haze in the lens. The threshold is typically selected to ensure that the lens meets the required quality standards. In many cases, the threshold is set below a certain percentage of the completely light value at bin N, such as 20, 15, 10, 5, 2, or 1 percent. In some cases, the threshold is value 187 below 10 percent. The threshold may be below 5 percent. It may be below 2 percent. By setting a threshold, lenses 150 with excessive haze 155 that is detectable or noticeable to the human eye can be identified and rejected using value 187. Different thresholds can be employed based on specific quality requirements and industry standards.

For instance, a threshold for rejecting a lens 150 may be any lens with an average pixel value threshold below 5 or 10 percent. In this case, the lens for FIG. 2 fails and is rejected for use, while the lens of FIG. 3 passes and can be used. A threshold of one of 7, 10 or 15 percent may be used.

When light 132 strikes the surface 152 of a transparent lens 150 the following interactions occur: some of light 132 is reflected from the surface 152 of the material, some of light 132 is refracted within the material (depending on thickness) and reflected from the second surface of edge 158 and/or 154, and/or some of light 132 passes through the lens 150 at light 157 at an angle (e.g., 90 degrees) which is determined by the refractive index of the material of lens 150, the angle of illumination of light 132, and the configuration of light source 130.

The light 157 that passes through the transparent material of lens 150 can be affected by irregularities within the lens including poorly dispersed particles, contaminants (i.e. dust particles) and/or air spaces. This causes the light 132 to scatter in different directions from the normal the degree of which being related to the size and number of irregularities present. Small irregularities cause the light 132 to scatter, or diffuse, in all directions whilst large ones cause the light to be scattered forward in a narrow cone shape. These two types of scattering behavior are known as wide angle scattering, which causes haze due to the loss of transmissive contrast, and narrow angle scattering a measure of clarity or the “see through quality” of the material based on a reduction of sharpness.

These factors may therefore be used for defining the transmitting properties of a transparent material of lens 150 as follows. Transmission may be the amount of light 132 that passes through the material of lens 150 without being scattered. Haze 187 may be, be proportional to and/or include the amount of light 132 that is subject to wide angle scattering in lens 150 at an angle greater than 2.5° from normal from normal of light 132. Clarity may be the amount of light that is subject to narrow area scattering at an angle less than 2.5° from normal of light 132.

### DESCRIPTION OF PROCESSES

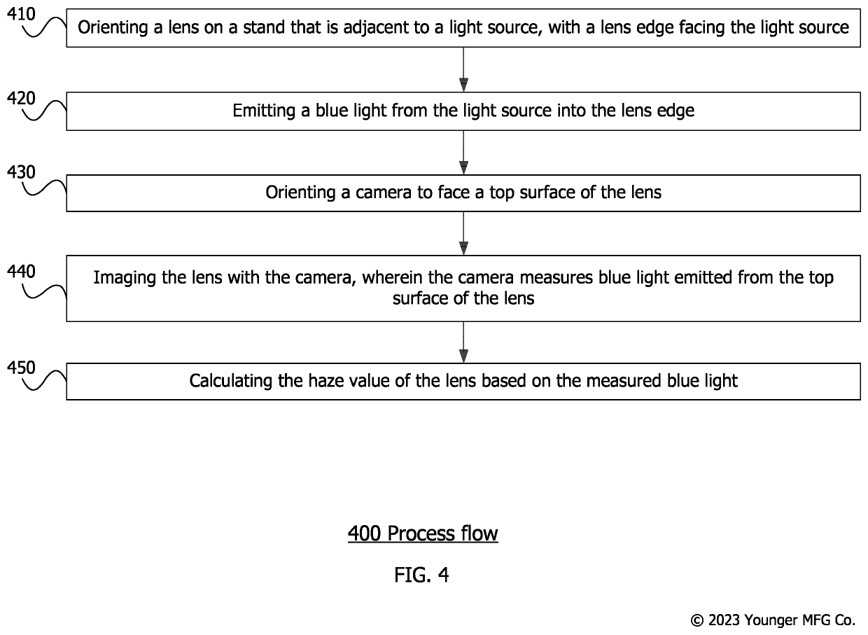

FIG. 4 shows a flow chart of an operating environment or process flow 400 for repeatable and quantifiable measurement of the haze present in an optical lens. Flow 400 may be performed by one or more components of system 100. The flow 400 starts at step 410 and can end at step 490, but the process can also be cyclical by returning to step 410 after step 490. For example, the process may return to step 410 to retest a lens 150 or replace that lens with and test a different lens. Flow 400 may be a method of detecting a haze value 187 of a lens 150.

Step 410 is orienting the lens 150 to be flat on a stand 120 that is adjacent to a light source 130, with the stand 120 positioning a lens edge 152 of the lens 150 to be facing the light source 130. Step 410 may include orienting the lens 150 to have top surface 154 facing cameral 140, edge 152 facing source 130 and edge 158 opposite of edge 152. Step 410 may include using clamps or a retaining device to removably retain the lens 150 in a fixed position 156 with respect to the light source 120 and the camera 140.

Step 420 is emitting a blue light 132 from the light source 130 into the lens edge 152. Step 420 may include emitting the blue light 132 and not emitting another color light. Step 420 may include emitting the blue light from diode (LED), a laser, or another source of light having blue light. Step 420 may include emitting the blue light 132 from the lens edge 152 to an opposing edge 158 of the lens 150, such as using a collimated beam having a circular cross-sectional diameter of between 0.5 and 3 mm. This diameter may be equal to or less than a thickness of the lens 150. It may be less than the thickness. In other cases, it may be greater than the thickness.

Step 430 is orienting a camera 140 to face a top surface 154 of the lens 150. Step 430 may include orienting a camera 140 to measure blue light 157 that is emitted from the top surface 154 as measured light 144. Step 430 may include orienting a camera 140 to have an imager facing and for imaging top surface 154. Step 430 may include orienting the camera to have a viewing direction, optical axis, principal axis, or principal ray of the camera oriented perpendicular to the top surface 154 of the lens 150. Step 430 may include measuring the blue light 157 that is emitted from the top surface 154 by measuring the blue light inside or between the top surface 154 and a bottom surface of the lens.

Step 440 is imaging the lens 150 with the camera 140, wherein the camera 140 measures blue light 157 emitted from the top surface 154 of the lens 150. Step 440 may include measuring a haze 155 of or in lens 150 as part of light 157 from which haze value 187 can be calculated. Step 440 may include measuring light 157 emitted from the lens 150 or from top surface 154. Step 440 may include measuring the emitted light 157 of an image of the lens 150 and haze 155 such as by producing measured light 144 of the emitted light 157. Step 440 may include measuring blue light 157 including other colors of light, such as when light 132 is emitted with colors other than blue. Step 430 may include measuring only the blue light 157 and not measuring another color light.

Step 420 may include only emitting the blue light 132 and/or step 440 may include only measuring the blue light 157. Step 420 may include only emitting the blue light 132 with and/or step 440 may include only measuring the blue light 157 wavelengths between 430 and 485 nanometers (nm).

Step 450 is calculating the haze value 187 of the lens 150 based on the measured blue light 144. Step 450 may include receiving light 144 used to calculate value 187 and calculating the haze value 187 of the lens haze 155 based on the measured blue light 144. Step 450 may include device 180 and/or calculator 186 calculating the haze value 187.

Step 450 may include using the measured blue light 144 to calculate an average pixel value of the light 144 from pixels of surface 154 for a histogram having of N bins that depict the brightness of individual pixels captured in the measured blue light 144 (e.g., of light 157) where bin 0 represents a bin of completely dark light of light 144, and bin N represents a bin of completely light/bright light of light 144. This average pixel value of the light 144 may be the haze value 187. Step 450 may include descriptions for FIGS. 1-3, such as using bins 0-N, or 0-256.

Step 450 may include where N is 256 bins and calculating the average pixel value using the equation:

$$Avg Pixel Value = \frac{1}{TotalPixelCount} * {\sum }_{bin = 0}^{255} ( bin * {PixelCount}_{b i n} ) .$$

Steps 410-440 may be performed in a box 110 having door 114. In some cases, steps 410-450 are performed in the box 110. The steps recite actions that may be distributed among different computing devices. The steps recite actions that may be combined with the actions of other steps, and the actions of a single step may be distributed into other separate steps.

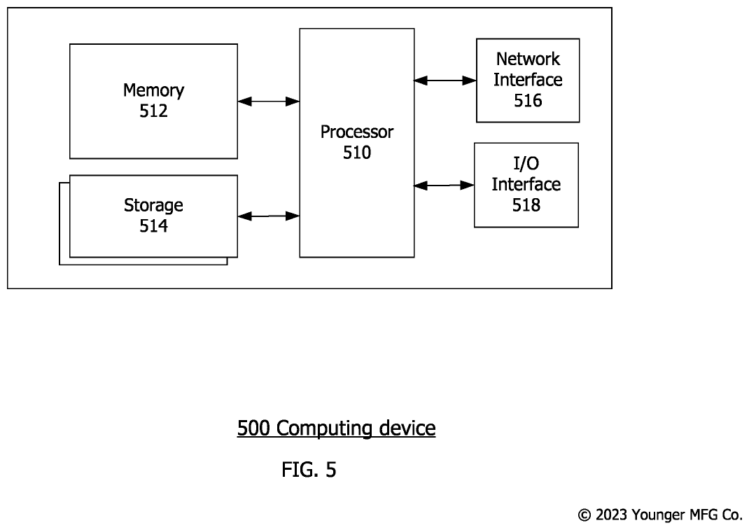

FIG. 5 is a block diagram of a computing device 500. The computing device 500 may be representative of any of device 180, device 170, a device for calculating histogram 200, a device for calculating histogram 300 and/or a device used to perform one or more steps or portions of the steps of process 400. The computing device 500 may be a desktop or laptop computer, a server computer, a cloud computer or network, a client computer, a network router, a network switch, a network node, a tablet, a smartphone or other mobile device. The computing device 500 may include software and/or hardware for providing the functionality and features of the units and/or steps described herein, such as for repeatable and quantifiable measurement of the haze 155 or haze value 187 present in an optical lens 150. The computing device 500 may include one or more of: logic arrays, memories, analog circuits, digital circuits, software, firmware and processors. The hardware and firmware components of the computing device 500 may include various specialized units, circuits, software and interfaces for providing the functionality and features of the units described herein.

The computing device 500 has a processor 510 coupled to a memory 512, storage 514, a network interface 516 and an I/O interface 518. The processor 510 may be or include one or more microprocessors, field programmable gate arrays (FPGAs), application specific integrated circuits (ASICs), programmable logic devices (PLDs) and programmable logic arrays (PLAs).

The memory 512 may be or include RAM, ROM, DRAM, SRAM and MRAM, and may include firmware, such as static data or fixed instructions, BIOS, system functions, configuration data, and other routines used during the operation of the computing device 500 and processor 510. The memory 512 also provides a storage area for data and instructions associated with applications and data handled by the processor 510. As used herein the term “memory” corresponds to the memory 512 and explicitly excludes transitory media such as signals or waveforms.

The storage 514 provides non-volatile, bulk or long-term storage of data or instructions in the computing device 500. The storage 514 may take the form of a magnetic or solid state disk, tape, CD, DVD, or other reasonably high capacity addressable or storage medium. Multiple storage devices may be provided or available to the computing device 500. Some of these storage devices may be external to the computing device 500, such as network storage or cloud-based storage. As used herein, the terms “storage” and “storage medium” correspond to the storage 514 and explicitly exclude transitory media such as signals or waveforms. In some cases, such as those involving solid state memory devices, the memory 512 and storage 514 may be a single device.

The network interface 516 includes an interface to a network such as a network that can be used to communicate network packets, network messages, text messages, telephone calls, faxes, wireless signals and/or wired power signals as described herein. The network interface 516 may be wired and/or wireless.

The I/O interface 518 interfaces the processor 510 to peripherals (not shown) such as displays, video and still cameras, microphones, user input devices (e.g., touchscreens, mice, keyboards and the like) and USB devices. In some cases, the I/O interface 518 includes the peripherals, such as displays, GUIs and user input devices, for being accessed by the user to input data, make selections and view displays.

In some cases, storage 514 is a non-volatile or a non-transitory machine-readable storage medium that includes all types of computer readable media, including magnetic storage media, optical storage media, and solid state storage media. It should be understood that the software can be installed in and sold with an application of box 110, device 170 and/or device 180. Alternatively, the software can be obtained and loaded into the box 110, device 170 and/or device 180, including obtaining the software via a storage medium or from any manner of network or distribution system, including from a server owned by the software creator or from a server not owned but used by the software creator. The software can be stored on a server for distribution over the Internet.

The embodiments of systems, units and processes herein for repeatable and quantifiable measurement of the haze 155 or haze value 187 present in an optical lens 150 may be implemented with machine readable storage media in a storage device included with or otherwise coupled or attached to a computing device. That is, the software may be stored in electronic, machine readable media. These storage media include magnetic media such as hard disks, optical media such as compact disks (CD-ROM and CD-RW) and digital versatile disks (DVD and DVD±RW); flash memory cards; and other storage media. As used herein, a storage device is a device that allows for reading and/or writing to a storage medium. Storage devices include hard disk drives, DVD drives, flash memory devices, and others.

The technologies and embodiments herein provide computing machine improvements in the systems and units and create specific purpose computing devices as the systems and units such as by using system 100, box 110, device 170 and/or device 180 for repeatable and quantifiable measurement of the haze 155 or haze value 187 present in an optical lens 150. System 100 and/or box 110 may be a haze meter for measuring a haze value 187 of a lens which is to be oriented on stand 120 such as by only emitting blue light into the lens and/or only measuring blue light in the lens.

The lens may be a blank that has not yet been processed, a final product lens for mounting in a frame, a sample of a lens material, or a lens at any stage of processing therebetween. The lens may be or comprise one or more optical materials including: thermoplastic polycarbonate, hard resin thermoset polymers, poly(urea-urethanes), polythiourethanes, episulfides, other sulfur-containing polymers with refractive indices higher than about 1.56, polystyrenes, polyamides, optical-grade nylon polymers, acrylics, polyacrylates, and polymethacrylates. The lens may include a hard coat; photochromic dye, film or layers; and/or polarizer dye, film or layers. The lens may have various layers of these materials and/or other optical material known for glasses or optical lenses. The lens may have a lens blank base layer of polyurethane with a second layer of photochromic material, such as formed from a liquid into a solid. The lens may have various base curvatures. It may have various optical grindings or prescriptions.

The haze 155 may influence the overall clarity or visual acuity of lens. The amount of haze measured 187 may be an amount of haze 155 or a haze value 187 as known in the art. The haze meter may measure the amount of haze or haze value 187, a value which may be part of a standard or known optical quantity. The amount of haze may depend on the amount of impurities in the lens or layers. The amount of haze may vary depending on amounts of additives mixed into the lens resin, such as photochromic dyes, UV absorbers, hindered amine light stabilizers (HALS), antioxidants, and mold release agents. Additionally, the amount of haze can be dependent on the intrinsic clearness of the lens with or without these additives. Greater amounts of additives and/or less intrinsically clear lenses generally lead to greater amounts of haze. The amount of haze may also appear to vary depending on the edge quality of the lens edge 152. A lens edge with high surface roughness may add between 10-12% haze to the average apparent value.

Although certain embodiments and numbers are provided herein, it is understood that the concepts described herein can have variations and different numbers. For example, although N=256 “bins” that depict the brightness of individual pixels are described, the number of bins N can vary, such as by being between 3 and 30,000. There may be between 20 and 500 bins. In some cases N is a fraction or multiple of the 256 bins. Also, various thresholds can be used to determine whether the of the lens passes or fails quality control. The example presented shows high and low haze lenses at FIGS. 2-3, but an acceptable threshold, such as either, or a number in between can be used to accept or reject lenses. In some cases, the average pixel value threshold of haze value 187 for an acceptable lens 150 may be less than 20, 15, 10 or 5 percent. In some cases, an acceptable threshold may be having the average pixel value threshold of below 20, 15, 10, 5, 2 or 1 percent. In some cases, an acceptable threshold may be having the largest brightness bin value below 100, 85, 68, 51, 34 17 or 10. Although the calculation of average pixel value is shown 187, another standard such as a standard deviation, mean square or other calculation can be used.

Embodiments are designed to have box 110 function at room temperature that should not exceed 80° F. (27° C.) and should not vary too rapidly. Although certain temperatures are described, other applicable temperatures are considered, such as not exceeding 70° F. or 90° F. An LED may be used as the source of light 130. The light source may be specifically selected or tuned to emit the blue light. The light may be a collimated beam having a circular cross-sectional diameter of between 0.5 and 3 mm. The diameter may be between 0.8, 1.0, 1.2 or 1.4 mm in diameter. The ideal target value of the diameter may fall between 1.0 and 1.2 mm. In one preferred version of the haze meter the diameter of the beam falls between 1.0 and 1.2 mm.

The type of camera 140 may vary, though the camera may be specifically selected or tuned to measure the blue channel or blue light emitted by the light. While it may be preferred that the camera and imaging system measure only a specific wavelength range of blue light, in some cases the light source emits only the desired wavelength range and the measurement is done in a light-controlled chamber. In some embodiments, the camera is a red, green, blue (RGB) camera with the R and G channels disabled so that the camera only captures or reads the B color. The camera may be a camera with a set of colors (RGB or other) with only the blue imaging enabled. The camera may be a spectrometer or other electro-optical system designed to measure the light emitted from the top surface of the lens, such as photodiode, amplifier, and signal measurement device. The optical system may measure only the blue light. In some embodiments, the device can use multiple cameras, not just one. The device can utilize more than one camera to capture the color and haze. This can help speed up color capture or measure lens haze from different angles in some cases.

It may be preferred that the camera/imaging system 140 measure only a specific wavelength range of blue light, such as blue light having a wavelength of 455 nm. In some cases, the light source emits only the desired wavelength range, such as blue light having a wavelength of 455 nm, and the measurement is done in a light-controlled chamber so only that wavelength of light can be detected or measured. Either the camera or light source can be controlled to measure or emit blue light having a wavelength of 455 nm. It is also considered that the wavelength range of both the emitted light and measured light can be controlled, such as to both be blue light having a wavelength of 455 nm.

The blue light wavelength of 455 nm may vary, for the camera 140 and/or emitter (e.g., source 130. The wavelength 455 may vary, such as to be one wavelength or a range of wavelengths between 430 and 485 nm. For example, the light may be 480 nm only; or may be a range of from 450 to 480 nm (inclusive). In one embodiment, light of one wavelength or a range of wavelengths at any variation in increments of plus or minus 5 nm within that range may be used instead of 455 nm. For example, a variation of plus or minus 10 nm provides that the light may be 440 nm only; or may be a range of from 445 to 465 nm (inclusive). In other embodiments, light at any variation in increments of plus or minus N nm within that range may be used instead of 455 nm, where N is between 1 and 20. For example, a variation of plus or minus 8 nm provides that the light may be 447 nm only; or may be a range of from 447 to 463 nm (inclusive).

Computing devices 170/180 and/or software of those devices may be used with and/or used for prompting the user to perform actions of the method for the haze meter described. However, software may not be needed, such as with the exception of storing the image data and/or calculating the resultant haze value 187. For example, the camera 140 can be attached to a display that shows the image of the haze for viewing by the user and manual determination of the resultant haze by a trained operator. In another case, the computing device and/or software calculates the resultant haze by calculating the average pixel value 187 from the histogram generated by the program. In some cases, the histogram generated by the program consists of 256 “bins” that depict the brightness of individual pixels in captured in the image. Bin 0 represents completely dark, bin 255 represents completely light. The calculation is done as the summation of the x-value (bin) multiplied by the bar height at that bin location (number of pixels present at that bin location). Dividing this by the total number of pixels in the image gives us the average pixel value 187:

$$Avg Pixel Value = \frac{1}{TotalPixelCount} * {\sum }_{bin = 0}^{255} ( bin * {PixelCount}_{b i n} )$$

In some cases, the “seg” or “segment” part of the lens that is oriented to be parallel with the LED beam 132 is an indent or intentional feature on a surface of the lens having a partial spherical or other curved shape and a straight or line segment. From a top perspective it may appear as a partial circle or partial oval that is bisected by a line to form a cup like shape. The “seg” may be along the length of the straight or line segment. The segment may be the part or area of a multifocal lens, such as a bifocal or trifocal lens, designed for reading or far-sighted correction.

The beam of light 132 may be collimated. It may be directional and/or coherent. The beam of light 132 may have a circular or have another cross-sectional shape across its direction of emission. The light source may be a LED, laser or other monochromatic source. It may be any source that can provide the wavelength(s) of emitted light described herein. In some cases, the wavelength of light may be within a range of 1, 2, 5 or 10 nm of a target wavelength.

The platform, stage or stand 120 dimensions may also vary. The lens may be placed convex or concave face up towards the camera 140. The height of the platform relative to the source 130 of light 132 may vary, and may depend on the thickness and/or curvature of the lens. The lens may be oriented so that the light 132 enters above the midpoint in height of the lens.

The proper alignment of the stage may be performed by various indexing methods, including by visual alignment. The lens is aligned on the stage such that the light enters through the side of the lens at edge 152. The light may be shined into a side of and through the middle of the lens towards the opposing side of the lens or edge 158, while the lens 150 is laying on the stage 120.

A single image or multiple images of the lens may be used for the calculation of haze. Each image may produce measured light 144. The sample or series name does not need to be unique, such as where the prior result has been recorded or is not needed. Each measurement may be a single image or single measured light 144. It may be more than one image, such as by being between 2 and 10 images.

The direction and/or intensity of light 132 may be varied between images and could potentially include more than a single LED or source 130. The direction of light 132 may be varied between images by changing the height at which the light enters the side of the lens edge 152; and/or the angle upwards and/or sideways at which the light enters the side of the lens. The intensity of light 132 may be varied between images by changing increasing or decreasing the intensity at predetermined, linear, exponential or random increments over the images. More than a single LED or source 130 can be used, such as to provide the variations noted above. More than a single LED source can be used, such as to simultaneously provide multiple light emissions as noted herein. The multiple emissions may include the direction and/or intensity of light variations noted above.

The test may be performed in a dark or lightless environment or box 110. The only light may be that of the meter's light source 130. In other cases, some other or ambient light may exist in the environment, as long as it does not include the light spectrum of the meter's light or source 130 and/or light spectrum sensed by the camera 140.

Also, various upper and/or lower boundaries of an acceptable lens for a series of images or data 144 can be used such as below +/−2, 5, 8, 10, 12, 15 or 20 percent for value 187. Calibration of the system 100 can occur at various time prior to or during use of the haze meter or testing of lenses.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” or “number” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A haze meter for measuring a haze value of a lens, the haze meter comprising:
a light proof box housing a stand, a light source and a camera;
the stand having an orientation to position the lens to be flat, adjacent to the light source, and have the lens edge facing the light source;
the light source is configured to emit a blue light into a lens edge of the lens;
the camera oriented to face a top surface of the lens, the camera is configured to measure blue light that is emitted from the top surface of the lens; and
a computing device is configured to calculate the haze value of the lens based on the measured blue light.

2. The haze meter of claim 1, wherein the light source is configured to only emit the blue light and the camera is configured to only measure the blue light.

3. The haze meter of claim 1, wherein the light source is at least one of an LED or a laser, wherein at least one: the light source is configured to only emit the blue light or the camera is configured to only measure the blue light.

4. The haze meter of claim 3, wherein the light source is configured to only emit the blue light with wavelengths between 430 and 485 nm; and wherein the camera is configured to only measure the blue light with wavelengths between 430 and 485 nm.

5. The haze meter of claim 3, wherein the light source configured to emit the blue light is configured to emit the blue light from the lens edge to an opposing edge of the lens using a collimated beam having a circular cross-sectional diameter of between 0.5 and 3 mm; wherein the camera orientation includes having a viewing direction oriented perpendicular to the top surface of the lens; wherein being configured to measure the blue light emitted from the top surface of the lens includes being configured to measure the blue light between the top surface and a bottom surface of the lens.

6. The haze meter of claim 1, wherein calculating the haze value includes using the measured blue light to calculate an average pixel value from a histogram having N bins that depict the brightness of individual pixels captured in the measured blue light where bin 0 represents completely dark, bin N represents completely light and calculating is done as the summation of the x-value of the bin multiplied by the bar height at that bin location which is a number of pixels present at that bin location, and dividing the summation by the total number of pixels in the image to get the average pixel value.

7. The haze meter of claim 6, wherein N is 256 bins, bin 0 represents completely dark, bin 255 represents completely light, wherein calculating the average pixel value uses the equation:
$$Avg Pixel Value = \frac{1}{TotalPixelCount} * {\sum }_{bin = 0}^{255} ( bin * {PixelCount}_{b i n} ) . ;$$
and wherein an acceptable haze threshold has the average pixel value threshold below 20, 15, 10, 5, 2 or 1 percent of the completely light.

8. The haze meter of claim 1, wherein the lens includes one or more of: an optical material; a hard coat; a photochromic dye, a film; a polarizer dye, layers of optical material known for glasses or optical lenses; a lens blank base layer of polyurethane with a second layer of photochromic material, such as formed from a liquid into a solid; various base curvatures; various optical grindings or prescriptions.

9. The haze meter of claim 1, wherein the box includes a door for mounting the lens on the stand and an external data connection from the computing device to the light source and the camera.

10. The haze meter of claim 1, wherein the computing device includes a user input device and a display, the user input device for receiving user selections to perform repeatable and quantifiable measurements of the haze; and where in the stand includes a mount for retaining the lens in a fixed position with respect to the light source and the camera.

11. A system for measuring a haze value of a lens, the system comprising:
a haze meter having;
a light source configured for only emitting a blue light into a lens edge of the lens;
a camera oriented to face a top surface of the lens, the camera configured for measuring only blue light that is emitted from the top surface of the lens;
a computing device having a user input device, a user output device, and a data connection to the haze meter;
the computing device having non-transitory computer instructions that when executed by the computing device cause the computing device to perform actions including:
causing input received at the user input device to control the light source emitting only the blue light and control the camera measuring only the blue light, and
calculating the haze value of the lens based on the measured blue light.

12. The system of claim 11, wherein the light source is configured to only emit the blue light and the camera is configured to only measure the blue light.

13. The system of claim 11, wherein the light source is at least one of an LED or a laser, wherein at least one: of the light source is configured to only emit the blue light or the camera is configured to only measure the blue light.

14. The system of claim 12, wherein the light source configured to emit the blue light is configured to emit the blue light from the lens edge to an opposing edge of the lens using a collimated beam having a circular cross-sectional diameter of between 0.5 and 3 mm; wherein the camera orientation includes having a viewing direction oriented perpendicular to the top surface of the lens; wherein measuring only the blue light that is emitted from the top surface of the lens includes measuring the blue light between the top surface and a bottom surface of the lens.

15. The system of claim 11, wherein calculating the haze value includes using the measured blue light to calculate an average pixel value from a histogram having N bins that depict the brightness of individual pixels captured in the measured blue light where bin 0 represents completely dark, bin N represents completely light and calculating is done as the summation of the x-value of the bin multiplied by the bar height at that bin location which is a number of pixels present at that bin location, and dividing the summation by the total number of pixels in the image to get the average pixel value.

16. A method of detecting a haze value of a lens, comprising:
orienting the lens to be flat on a stand adjacent to a light source, the stand positioning a lens edge of the lens facing the light source;
emitting a blue light from the light source into the lens edge;
orienting a camera to face a top surface of the lens;
imaging the lens with the camera, wherein the camera measures blue light emitted from the top surface of the lens; and
calculating the haze value of the lens based on the measured blue light.

17. The method of claim 16, wherein emitting the blue light includes emitting only the blue light and wherein measuring the blue light includes measuring only the blue light.

18. The method of claim 16, wherein emitting the blue light is emitting the blue light from at least one of an LED or a laser, and wherein at least one: emitting the blue light is emitting only the blue light or measuring the blue light is measuring only the blue light.

19. The method of claim 18, wherein emitting the blue light includes emitting the blue light from the lens edge to an opposing edge of the lens using a collimated beam having a circular cross-sectional diameter of between 0.5 and 3 mm; wherein orienting the camera includes orienting the camera to have a viewing direction oriented perpendicular to the top surface of the lens; wherein measuring the blue light includes measuring blue light that is emitted from the top surface of the lens includes measuring the blue light between the top surface and a bottom surface of the lens.

20. The method of claim 15, wherein calculating the haze value includes using the measured blue light to calculate an average pixel value from a histogram having N bins that depict the brightness of individual pixels captured in the measured blue light where bin 0 represents completely dark, bin N represents completely light and calculating is done as the summation of the x-value of the bin multiplied by the bar height at that bin location which is a number of pixels present at that bin location, and dividing the summation by the total number of pixels in the image to get the average pixel value.
